(19) United States
(12) Patent Application Publication
(10) Pub. No.: US 2026/0196139 A1
(43) Pub. Date: Jul. 9, 2026

(54) PROCESS MODEL AND 3D MODEL INTEGRATED EDUCATION AND TRAINING SYSTEM, AND METHOD OF GENERATING SAME

(71) Applicant: NEWGEN I&S CO., LTD., Busan (KR)

(72) Inventor: Sang Gyu PAKR, Busan (KR)

(21) Appl. No.: 19/133,286

(22) PCT Filed: Nov. 28, 2023
(86) PCT No.: PCT/KR2023/019340

§ 371 Date: May 28, 2025

(30) Foreign Application Priority Data
Dec. 2, 2022 (KR) 10-2022-0166362

(51) Int. Cl. G09B 5/02; G06F 9/451; G06T 17/00

(52) U.S. Cl. CPC G09B 5/02; G06F 9/451; G06T 17/00; G06T 2200/24

(57) ABSTRACT

A process model and 3D model integrated education and training system and a method of generating same are provided. The process model and 3D model integrated education and training system according to an embodiment of the present invention comprises: an education model integration unit that generates an integrated education model by linking a process model with a 3D model; a visualization information linkage unit that links visualization information of the process model and the 3D model for the integrated education model; and an output UI determination unit that determines a UI according to information on an output device for the integrated education model and outputs determined UI information to the output device.

### TECHNICAL FIELD

The present invention relates to an education and training system, and more particularly, to a process model and 3D model integrated education and training system which can acquire and integrate information about the process model and 3D model and provide it to a user for simulation education training in which the advantages of the process model and the 3D model are merged, and a method of generating the same.

### BACKGROUND ART

Conventionally, an OTS (operation training simulator), which is a simulator education and training system utilizing a process model, has been used for the education and training of users (workers). Recently, in order to raise the degree of devotion of education and training by utilizing Fourth Industrial Revolution technologies, the development of an ITS (immersive training simulator), which is a simulator education and training system utilizing a 3D model, has been activated.

### DETAILED DESCRIPTION OF THE INVENTION

### Technical Problem

An embodiment of the present invention aims to provide a process model and 3D model integrated education and training system which can provide effective education and training having a high power of expression while raising the degree of devotion, through a combination of a process model and a 3D model, which are respectively utilized in a traditionally used education and training and a recently developed education and training, and a method of generating the same.

### Technical Solution

According to certain aspects of the present invention, a process model and 3D model integrated education and training system is provided. The process model and 3D model integrated education and training system comprises: an education model integration unit that generates an integrated education model by linking a process model with a 3D model; a visualization information linkage unit that links visualization information of the process model and the 3D model for the integrated education model; and an output UI determination unit that determines a UI according to information on an output device for the integrated education model and outputs the determined UI information to the output device.

The education model integration unit comprises: a process model information acquisition module that acquires the process model information; a 3D model information acquisition module that acquires the 3D model information; and an integrated model visualization module that performs visualization by mutually linking the process model information and the 3D model information.

The process model information may comprise an already created 2D-based process piping flow diagram (PFD), a piping and instrumentation diagram (P&ID), a human machine interface (HMI) screen, or a 2D layout diagram, and the 3D model information may comprise the process model information or information acquired by converting an actual site into 3D through photographed images.

The integrated model visualization module may acquire tag names for at least one of an equipment, a valve, an instrument, or an electrical panel, which is a target object included in the process model information and the 3D model information, compare the acquired tag names, and divide the target objects matching each other into groups to perform information sharing and visualization.

The visualization information linkage unit may comprise: an IoT information acquisition module that acquires calculated IoT reference information and measured IoT information from the process model; an IoT information visualization module that visualizes the IoT information in a 3D model corresponding to a source; a theory information classification module that acquires at least one of laws, regulations, guidelines, drawings, videos, photos, and manual information concerning an industry group including the process model and the 3D model as theory information, and classifies the theory information according to preset criteria; and a theory information call module that tags the classified theory information to a particular object among the integrated education models according to preset criteria, and calls the tagged theory information according to a user's action.

The IoT information may comprise operation information and state information which can be measured through a particular sensor in a target object, the operation information comprises any one of an operation state/non-operation state, and the state information comprises at least one of temperature, pressure, flow rate, rotational speed, speed, electric energy, voltage, current, and level.

The state information may be acquired when the operation information of the target object is in the operation state, and the visualization may be performed using at least one of text, color, and graph.

The output UI determination unit may comprise: an output device information acquisition module that acquires, as output device information, information on the number and type of the output devices connected to output the integrated education model; and a UI output module that determines the UI information to be output using the output device information and the preset UI output reference information, and outputs it to the output device.

According to certain other aspects of the present invention, a method of generating a process model and 3D model integrated education and training system is provided. The method of generating a process model and 3D model integrated education and training system may comprise a step of generating an integrated education model by performing linkage between a process model and a 3D model in an education model integration unit; a step of linking visualization information of the process model and the 3D model to the integrated education model in a visualization information linkage unit; and a step of determining a UI according to output device information for the integrated education model in an output UI determination unit, and outputting the determined UI information to the output device.

The step of generating an integrated education model may comprise: a step of acquiring the process model information; a step of acquiring the 3D model information; and a step of performing visualization through mutual linkage between the process model information and the 3D model information.

The process model information may comprise an already created 2D-based process piping flow diagram (PFD), a piping and instrumentation diagram (P&ID), a human machine interface (HMI) screen, or a 2D layout diagram, and the 3D model information may comprise the process model information or information acquired by converting an actual site into 3D through photographed images.

The step of performing visualization through mutual linkage may acquire tag names for at least one of an equipment, a valve, an instrument, or an electrical panel, which is a target object included in the process model information and the 3D model information, compare the acquired tag names, and divide the target objects matching each other into groups to perform information sharing and visualization.

The step of linking visualization information may comprise: a step of acquiring calculated IoT reference information and measured IoT information from the process model; a step of visualizing the IoT information in a 3D model corresponding to a source; a step of acquiring at least one of laws, regulations, guidelines, drawings, videos, photos, and manual information concerning an industry group including the process model and the 3D model as theory information, and classifying the theory information according to preset criteria; and a step of tagging the classified theory information to a particular object among the integrated education models according to preset criteria, and calling the tagged theory information according to a user's action.

The IoT information may comprise operation information and state information which can be measured through a particular sensor in a target object, the operation information may comprise any one of an operation state/non-operation state, and the state information may comprise at least one of temperature, pressure, flow rate, rotational speed, speed, electric energy, voltage, current, and level.

The state information may be acquired when the operation information of the target object is in the operation state, and the visualization may be performed using at least one of text, color, and graph.

The step of outputting the determined UI information to the output device may comprise: a step of acquiring, as output device information, information on the number and type of the output devices connected to output the integrated education model; and a step of determining the UI information to be output using the output device information and the preset UI output reference information, and outputting it to the output device.

### Advantageous Effects

According to specific embodiments of the present invention, a process model and 3D model integrated education and training system and a method of generating the same can apply information of the process model to a 3D model and visualizes it in the 3D model, which have the effect of helping users in their education and training.

In addition, various effects that are directly or indirectly grasped through the present specification can be provided.

### BRIEF DESCRIPTION OF THE DRAWINGS

FIG. 1 is a block diagram of a process model and 3D model integrated education and training system according to an embodiment of the present invention.

FIG. 2 is a block diagram of an education model integration unit of FIG. 1.

FIG. 3 is a block diagram of a visualization information linkage unit of FIG. 1.

FIG. 4 is a block diagram of an output UI determination unit of FIG. 1.

FIG. 5 is a flowchart of a method of generating a process model and 3D model integrated education and training system according to an embodiment of the present invention.

FIG. 6 is a flowchart for step S11 of FIG. 5.

FIG. 7 is a flowchart for step S13 of FIG. 5.

FIG. 8 is a flowchart for step S15 of FIG. 5.

### DETAILED DESCRIPTION OF THE EMBODIMENTS

Hereinafter, various embodiments of the present invention will be described in detail with reference to the accompanying drawings so that those skilled in the art can easily carry out them. The present invention may be modified in various different ways, and is not limited to the embodiments set forth herein. In the drawings, descriptions of parts unrelated to the description of the present disclosure will be omitted in order to clearly describe the present invention, and same reference numerals designate same or like elements throughout the description.

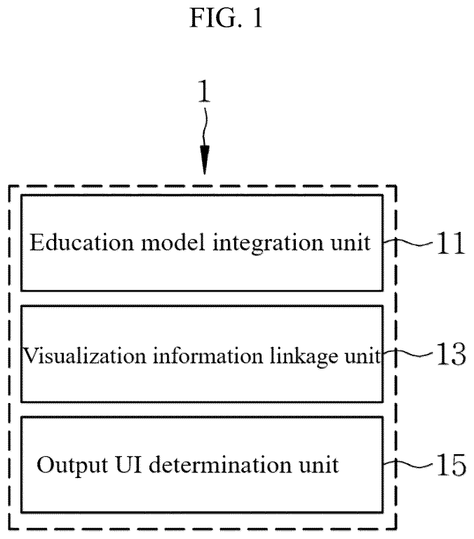

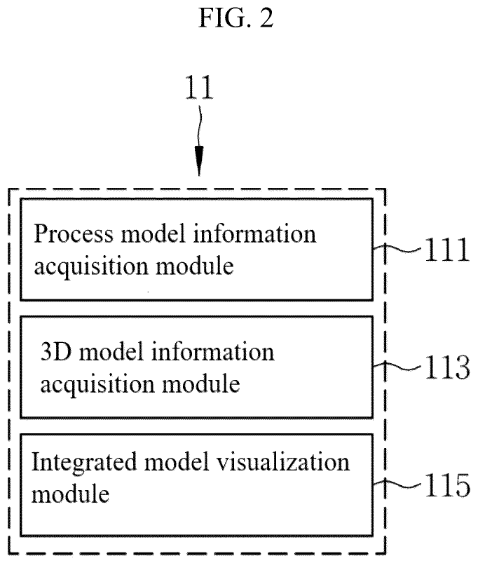

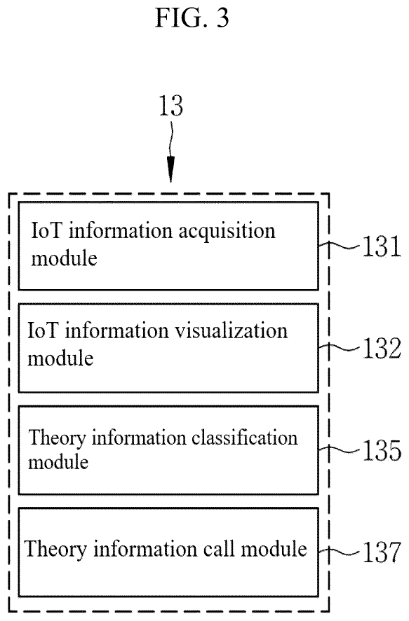

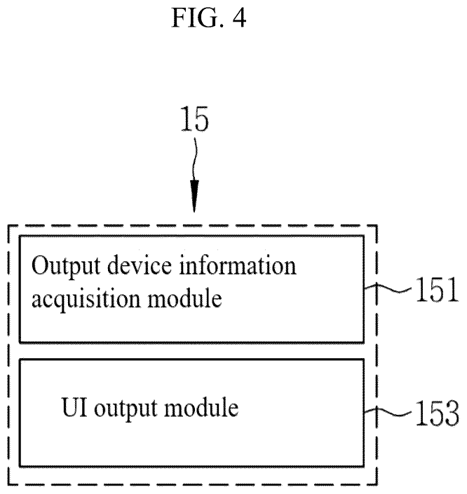

FIG. 1 is a block diagram of a process model and 3D model integrated education and training system according to an embodiment of the present invention. FIG. 2 is a block diagram of an education model integration unit of FIG. 1. FIG. 3 is a block diagram of a visualization information linkage unit of FIG. 1. FIG. 4 is a block diagram of an output UI determination unit of FIG. 1.

The process model and 3D model integrated education and training system according to an embodiment of the present invention will be described in detail below with reference to FIGS. 1 to 4. In addition, for convenience, the process model and 3D model integrated education and training system according to an embodiment of the present invention will be referred to as an integrated education and training system hereinafter.

Referring to FIG. 1, the integrated education and training system 1 according to an embodiment of the present invention is configured to include an education model integration unit 11, a visualization information linkage unit 13, and an output UI determination unit 15. The integrated education and training system according to the present invention is preferably configured to provide a customized education and training system to a user (trainer) by merging an education and training system using a process model that has been conventionally used and an education and training system using a 3D model that has been recently studied and developed.

The education model integration unit 11 is configured to generate an integrated education model by linking a process model with a 3D model. For this purpose, the education model integration unit 11 may be configured to include a process model information acquisition module 111, a 3D model information acquisition module 113, and an integrated model visualization module 115 as shown in FIG. 2.

For the purpose of the present invention described above, the education model integration unit 11 is configured to perform linkage between the process model and the 3D model to generate an integrated education model. The education model integration unit 11 may be configured to include a process model information acquisition module 111, a 3D model information acquisition module 113, and an integrated model visualization module 115 as shown in FIG. 2.

The process model information acquisition module 111 is configured to acquire process model information, and the 3D model information acquisition module 113 is configured to acquire 3D model information. All of the information acquired here may be information within a region that must be generated for education and training.

The integrated model visualization module 115 is configured to perform visualization through mutual linkage between process model information and 3D model information. Here, the process model information may include at least one of an already created or already acquired 2D-based process piping flow diagram (PFD), a piping and instrumentation diagram (P&ID), a human machine interface (HMI) screen, or a 2D layout diagram. Further, the 3D model information may be information acquired by converting process model information into 3D through photographed images, or may be information obtained by converting photographed images of an actual site into 3D. In this case, a device capable of converting a photographed image into 3D, such as a lidar, radar, or True Depth camera, may be used as the photographing device.

The integrated model visualization module 115 may acquire tag names for at least one of an equipment, a valve, an instrument, or an electrical panel, which is a target object included in the process model information and the 3D model information, compares the acquired tag names, and divides the target objects matching each other into groups to perform information sharing and visualization. The process model information and the 3D model information may include the same object because they visualize the same space in 2D and 3D. Therefore, in order to determine the same object, the integrated model visualization module 115 may acquire tag names that are already tagged to the target objects included in the process model information and the 3D model information, compare the acquired tag names, divide the target objects having tag names matching with each other in two pieces of model information into groups, perform information sharing by copying target object-related information included in at least one of two pieces of model information to the other piece of model information, and visualizing the copied information, thereby generating an integrated teaching model.

The visualization information linkage unit 13 according to an embodiment of the present invention is configured to link the visualization information of the process model and the 3D model for the integrated education model. For this purpose, the visualization information linkage unit 13 may be configured to include an IoT information acquisition module 131, an IoT information visualization module 133, a theory information classification module 135, and a theory information call module 137 as shown in FIG. 3.

The IoT information acquisition module 131 is configured to acquire calculated IoT reference information and measured IoT information from the process model. The IoT reference information calculated from the process model may be information about objects for which measurement information is required among particular objects that are shown in the process piping flow diagram, design diagram, or layout diagram. Here, the IoT reference information may be determined according to the type of measurement information, When a numerical value is measured, the IoT reference information may include a reference value that distinguishes the safety grade along with a safety grade that is classified into multiple grades, such as safe, warning, and danger. When measuring the presence or absence of operation, the IoT reference information may include an operation state or a non-operation state.

In summary, the IoT information acquisition module 131 may be configured to acquire a reference value for checking whether or not an object is abnormal due to a change in the IoT state from the process model.

Further, when IoT reference information is acquired, the IoT information acquisition module 131 may acquire measured IoT information. The IoT information acquisition module 131 may acquire operation information and state information, which are information which can be measured through a particular sensor in the target object, as measured IoT information. The operation information may include either the operation state or the non-operation state of the target object, and the state information may include at least one of temperature, pressure, flow rate, rotational speed, speed, electric energy, voltage, current, and level.

Further, as an example, the state information may be acquired only when the operation information of the target object is in the operation state.

When IoT reference information and measured IoT information are acquired in the IoT information acquisition module 131, the IoT information visualization module 133 is configured to visualize the IoT information in a 3D model corresponding to a source. As described above, the IoT information acquisition module 131 is configured to acquire IoT reference information and measured IoT information for the target object. Therefore, the IoT information visualization module 133 can be configured to check the object from which IoT information is acquired based on the tag name of the acquired IoT information, and visualize the IoT information at the position of the corresponding object in the 3D model.

Here, the visualization refers to outputting IoT information to visual information using text, color, and graphs. When both IoT reference information and measured IoT information are output, different visualization processes are performed on both pieces of information, thereby allowing the differences to be intuitively confirmed. Further, the visualized information may also be displayed using instruments that are actually used.

The visualization information linkage unit 13 can classify theory information and output the classified theory information through the integrated education and training system 1, and for this purpose, it can include a theory information classification module 135 and a theory information call module 137.

The theory information classification module 135 can classify theory information including at least one of laws, regulations, guidelines, drawings, videos, photos, and manual information according to preset criteria. Here, the theory information may be information about an industry group including a process model and a 3D model, and the preset classification criteria may preferably use a tag name as described above.

The theory information call module 137 is configured to tag the classified theory information to a particular object included in the integrated education and training system 1 according to preset criteria, and call the tagged theory information according to the user's action.

The output UI determination unit 15 is configured to determine the UI according to the output device information for the integrated education model, and output the determined UI information to the output device. For this purpose, the output UI determination unit 15 according to an embodiment of the present invention may be configured to include an output device information acquisition module 151 and a UI output module 153, as shown in FIG. 4.

The output device information acquisition module 151 is configured to acquire information about the number and type of output devices connected to output the integrated education model as output device information. In the present invention, the information can be output to users (educators) through various output devices. Examples of the output devices include output devices capable of outputting visual information, such as a monitor device, a VR device, an AR device, and an MR device.

The output device information acquisition module 151 can acquire information about each output device connected through a wired or wireless communication network, and distinguish the type of the corresponding output device. Through this, the output device information acquisition module 151 can acquire information about the form and number in which the integrated education model of the present invention should be output.

When information about the form and number of output devices is acquired in the output device information acquisition module 151, the UI output module 153 is configured to determine UI information to be output to the outside using the output device information and the preset UI output reference information, and output the determined UI information to each output device.

The UI output module 153 can use the form of the output device (monitor, HMD device, etc.) and the number to be output as preset UI output reference information, and determine the UI to be output according to the form and number acquired as the output device information, and output it to the user.

Meanwhile, the process model and 3D model integrated education and training system according to an embodiment of the present invention may be configured to further include a user input/output information processing unit (not shown) in order to provide theoretical education to the user using the same.

Here, the user input/output information processing unit may be configured to include an input/output information acquisition module that acquires information input or output through various terminals capable of input or output possessed by a user using an integrated education model, a user-specific input/output information storage module that classifies and stores information acquired from the input/output information acquisition module by each user, a storage information recovery module that checks the currently connected and authenticated user as needed and recovers corresponding information from the user-specific input/output information storage module, and a system error check module that checks abnormal system errors of the integrated education and training system. The present invention can provide a user with integrated education and training of process models and 3D models by using a user input/output information processing unit, and guide the user to be re-educated by providing re-education information regarding parts of the user's education and training results in which the proficiency falls below the standard through an education and training feedback module which can be included further according to settings.

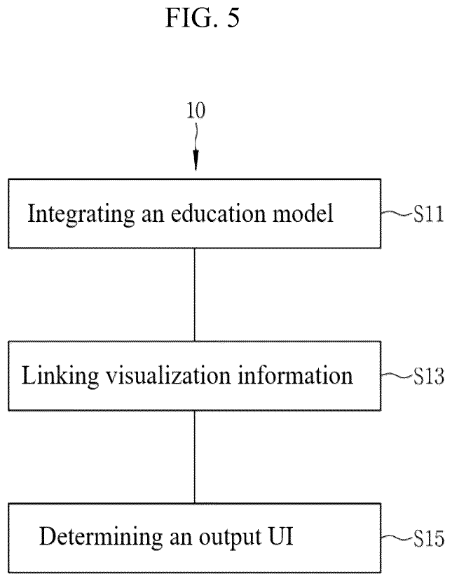

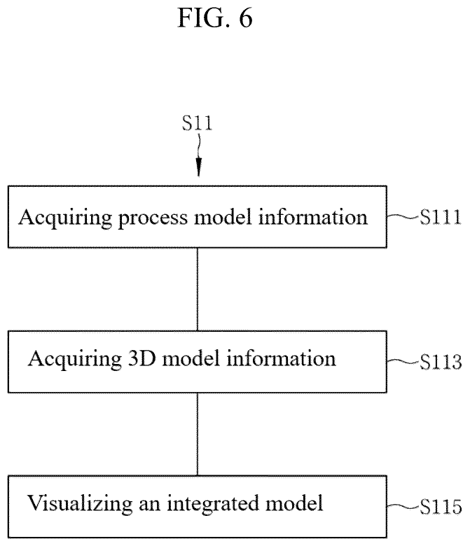

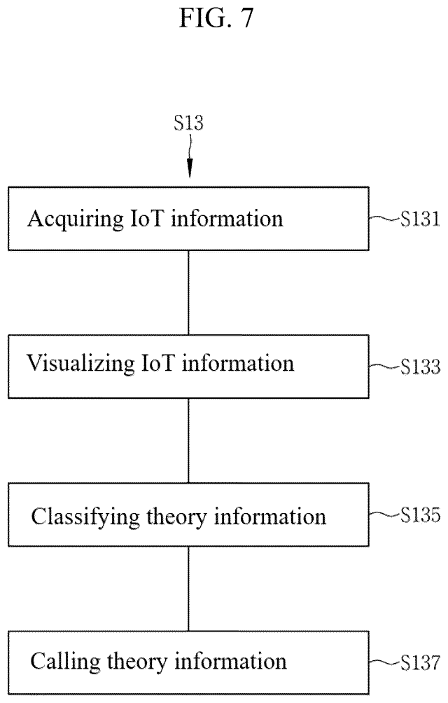

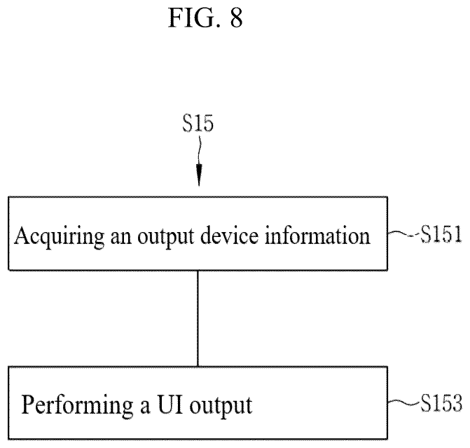

Meanwhile, FIGS. 5 to 8 show a method of generating a process model and 3D model integrated education and training system according to an embodiment of the present invention. FIG. 5 is a flowchart of a method of generating a process model and 3D model integrated education and training system according to an embodiment of the present invention, FIG. 6 is a flowchart for step S11 of FIG. 5, FIG. 7 is a flowchart for step S13 of FIG. 5, and FIG. 8 is a flowchart for step S15 of FIG. 5.

Hereinafter, for the convenience of explanation, the method of generating a process model and 3D model integrated education and training system according to an embodiment of the present invention is referred to as a method of generating an integrated education and training system, and will be described using the systems of FIGS. 1 to 4, but the present invention is not limited thereto.

Referring to FIG. 5, the method 10 of generating an integrated education and training system according to an embodiment of the present invention includes a step S11 of integrating an education model, a step S13 of linking visualization information, and a step S15 of determining an output UI. The integrated education and training system according to the present invention preferably provides a customized education and training system to a user (trainer) by merging an education and training system using a process model that has been conventionally used with an education and training system using a 3D model that has been recently studied and developed.

The step S11 of integrating the educational model uses the education model integration unit to perform linkage between the process model and the 3D model for the purpose of the present invention to generate an integrated training model. The step S11 of integrating the educational model comprises a step S111 of acquiring process model information, a step S113 of acquiring 3D model information, and a step S115 of performing integrated model visualization as shown in FIG. 6.

The step S111 of acquiring process model information is configured to acquire process model information, and the step S113 of acquiring 3D model information is configured to acquire 3D model information. All information acquired here may be information within a field that must be generated for education and training.

The step S115 of performing integrated model visualization is configured to perform visualization through mutual linkage between the process model information and the 3D model information. Here, the process model information may include at least one of an already created or already acquired 2D-based process piping flow diagram (PFD, Piping Flow Diagram), a piping and instrumentation diagram (P&ID), a human machine interface (HMI) screen, a 2D layout diagram, or a 2D design diagram. Further, the 3D model information may be information acquired by converting process model information into 3D through photographed images, or may be information acquired by converting photographed images of an actual site into 3D. In this case, a device capable of converting a photographed image into 3D, such as a lidar, radar, or True Depth camera, may be used as the photographing device.

The step S115 of performing integrated model visualization may acquire tag names for at least one of an equipment, a valve, an instrument, or an electrical panel, which is a target object included in the process model information and the 3D model information, compares the acquired tag names, and divides the target objects matching each other into groups to perform information sharing and visualization. The process model information and the 3D model information may include the same object because they visualize the same space in 2D and 3D. Therefore, in order to determine the same object, the step S115 of performing integrated model visualization may acquire tag names that are already tagged to the target objects included in the process model information and the 3D model information, compare the acquired tag names, divide the target objects having tag names matching with each other in two pieces of model information into groups, perform information sharing by copying target object-related information included in at least one of the two pieces of model information to the other piece of model information, and visualizing the copied information, thereby generating an integrated teaching model.

The step S13 of linking visualization information according to an embodiment of the present invention is configured to link visualization information of the process model and the 3D model for the integrated education model using the visualization information linking unit. For this purpose, the step S13 of linking visualization information may be configured to include a step S131 of acquiring IoT information, a step S133 of visualizing IoT information, a step S135 of classifying theory information, and a step S137 of calling theory information as shown in FIG. 7.

The step S131 of acquiring IoT information is configured to acquire calculated IoT reference information and measured IoT information from the process model. The IoT reference information calculated from the process model may be information about objects for which measurement information is required among particular objects that are shown in the process piping flow diagram, design diagram, or layout diagram. Here, the IoT reference information may be determined according to the type of measurement information, When a numerical value is measured, the IoT reference information may include a reference value that distinguishes the safety grade along with a safety grade that is classified into multiple grades, such as safe, warning, and danger. When measuring the presence or absence of operation, the IoT reference information may include an operation state or a non-operation state.

In summary, the step S131 of acquiring IoT information may be configured to acquire a reference value for checking whether or not an object is abnormal due to a change in the IoT state from the process model.

Further, when IoT reference information is acquired, the step S131 of acquiring IoT information may acquire measured IoT information. The step S131 of acquiring IoT information may acquire operation information and state information, which are information which can be measured through a particular sensor in the target object, as measured IoT information. The operation information may include either the operation state or the non-operation state of the target object, and the state information may include at least one of temperature, pressure, flow rate, rotational speed, speed, electric energy, voltage, current, and level.

Further, as an example, the state information may be acquired only when the operation information of the target object is in the operation state.

When IoT reference information and measured IoT information are acquired in the step S131 of acquiring IoT information, the step S133 of visualizing the IoT information is configured to visualize the IoT information in a 3D model corresponding to a source. As described above, the step S131 of acquiring IoT information may be configured to acquire IoT reference information and measured IoT information for the target object. Therefore, the step S133 of visualizing the IoT information can be configured to check the object from which IoT information is acquired based on the tag name of the acquired IoT information, and visualize the IoT information at the position of the corresponding object in the 3D model.

Here, the visualization refers to outputting IoT information to visual information using text, color, and graphs. When both IoT reference information and measured IoT information are output, different visualization processes are performed on both pieces of information, thereby allowing the differences to be intuitively confirmed. Further, the visualized information may also be displayed using instruments that are actually used.

The step S13 of linking visualization information can classify theory information and output the classified theory information through the integrated education and training system, and for this purpose, it can include a step S135 of classifying theory information and a step S137 of calling theory information.

The step S135 of classifying theory information can classify theory information including at least one of laws, regulations, guidelines, drawings, videos, photos, and manual information according to preset criteria. Here, the theory information may be information about an industry group including a process model and a 3D model, and the preset classification criteria may preferably use a tag name as described above.

The step S137 of calling theory information is configured to tag the classified theory information to a particular object included in the integrated education and training model according to preset criteria, and call the tagged theory information according to the user's action.

The step S15 of determining an output UI is configured to determine the UI according to the output device information for the integrated education model, and output the determined UI information to the output device. For this purpose, the step S15 of determining an output UI according to an embodiment of the present invention may be configured to include a step S151 of acquiring an output device information and a step S153 of performing a UI output, as shown in FIG. 8.

The step S151 of acquiring an output device information is configured to acquire information about the number and type of output devices connected to output the integrated education model as output device information. In the present invention, the information can be output to users (educators) through various output devices. Examples of the output devices include output devices capable of outputting visual information, such as a monitor device, a VR device, an AR device, and an MR device.

The step S151 of acquiring an output device information can acquire information about each output device connected through a wired or wireless communication network, and distinguish the type of the corresponding output device. Through this, the step S151 of acquiring an output device information can acquire information about the form and number in which the integrated education model of the present invention should be output.

When information about the form and number of output devices is acquired in the step S151 of acquiring an output device information, the step S153 of performing a UI output is configured to determine UI information to be output to the outside using the output device information and the preset UI output reference information, and output the determined UI information to each output device.

The step S153 of performing a UI output may use the form of the output device (monitor, HMD device, etc.) and the number to be output as preset UI output reference information, and determine the UI to be output according to the form and number acquired as the output device information, and output it to the user.

Meanwhile, the process model and 3D model integrated education and training method according to an embodiment of the present invention may be configured to further include a step of processing a user input/output information (not shown) in order to provide theoretical education to the user using the same.

Here, the step of processing a user input/output information may be performed using a user input/output information, and include a step of acquiring information that is input or output through various terminals capable of input or output possessed by a user using the integrated training model, a step of classifying and storing the acquired information by each user in the step of acquiring the input or output information, and a step of checking the currently connected and authenticated user as needed and recovering the corresponding information from the stored user input/output information, and a step of checking abnormal system errors in an integrated education and training method.

Specific embodiments of the present invention are described and shown above, however, the scope of the present invention is not limited to the embodiments provided herein, and those skilled in the art who understand the sprit and idea of the present invention will be able to easily propose various different embodiments though the addition, change, modification, deletion or the like of components, which are also within the scope of the present invention.

### Industrial Applicability

The present invention relates to a process model and 3D model integrated education and training system, and thus has industrial applicability.

1. A process model and 3D model integrated education and training system comprising:
an education model integration unit that generates an integrated education model by linking a process model with a 3D model;
a visualization information linkage unit that links visualization information of the process model and the 3D model for the integrated education model; and
an output UI determination unit that determines a UI according to information on an output device for the integrated education model and outputs the determined UI information to the output device.

2. The process model and 3D model integrated education and training system according to claim 1, wherein the education model integration unit comprises:
a process model information acquisition module that acquires the process model information;
a 3D model information acquisition module that acquires the 3D model information; and
an integrated model visualization module that performs visualization by mutually linking the process model information and the 3D model information.

3. The process model and 3D model integrated education and training system according to claim 2, wherein:
the process model information comprises an already created 2D-based process piping flow diagram (PFD), a piping and instrumentation diagram (P&ID), a human machine interface (HMI) screen, or a 2D layout diagram,
the 3D model information comprises the process model information or information acquired by converting an actual site into 3D through photographed images.

4. The process model and 3D model integrated education and training system according to claim 2, wherein the integrated model visualization module
acquires tag names for at least one of an equipment, a valve, an instrument, or an electrical panel, which is a target object included in the process model information and the 3D model information, compares the acquired tag names, and divides the target objects matching each other into groups to perform information sharing and visualization.

5. The process model and 3D model integrated education and training system according to claim 1, wherein the visualization information linkage unit comprises:
an IoT information acquisition module that acquires calculated IoT reference information and measured IoT information from the process model;
an IoT information visualization module that visualizes the IoT information in a 3D model corresponding to a source;
a theory information classification module that acquires at least one of laws, regulations, guidelines, drawings, videos, photos, and manual information concerning an industry group including the process model and the 3D model as theory information, and classifies the theory information according to preset criteria; and
a theory information call module that tags the classified theory information to a particular object among the integrated education models according to preset criteria, and calls the tagged theory information according to a user's action.

6. The process model and 3D model integrated education and training system according to claim 5, wherein:
the IoT information comprises operation information and state information which can be measured through a particular sensor in a target object, the operation information comprises any one of an operation state/non-operation state, and the state information comprises at least one of temperature, pressure, flow rate, rotational speed, speed, electric energy, voltage, current, and level.

7. The process model and 3D model integrated education and training system according to claim 6, wherein:
the state information is acquired when the operation information of the target object is in the operation state, and
the visualization is performed using at least one of text, color, and graph.

8. The process model and 3D model integrated education and training system according to claim 1, wherein the output UI determination unit comprises:
an output device information acquisition module that acquires, as output device information, information on the number and type of the output devices connected to output the integrated education model; and
a UI output module that determines the UI information to be output using the output device information and the preset UI output reference information, and outputs it to the output device.

9. A method of generating a process model and 3D model integrated education and training system, the method comprising the steps of:
generating an integrated education model by performing linkage between a process model and a 3D model in an education model integration unit;
linking visualization information of the process model and the 3D model to the integrated education model in a visualization information linkage unit; and
determining a UI according to output device information for the integrated education model in an output UI determination unit, and outputting the determined UI information to the output device.

10. The method of generating a process model and 3D model integrated education and training system according to claim 9, wherein the generating an integrated education model comprises:
acquiring the process model information;
acquiring the 3D model information; and
performing visualization through mutual linkage between the process model information and the 3D model information.

11. The method of generating a process model and 3D model integrated education and training system according to claim 10, wherein:
the process model information comprises an already created 2D-based process piping flow diagram (PFD), a piping and instrumentation diagram (P&ID), a human machine interface (HMI) screen, or a 2D layout diagram, and
the 3D model information comprises the process model information or information acquired by converting an actual site into 3D through photographed images.

12. The method of generating a process model and 3D model integrated education and training system according to claim 10, wherein the performing visualization through mutual linkage
acquires tag names for at least one of an equipment, a valve, an instrument, or an electrical panel, which is a target object included in the process model information and the 3D model information, compares the acquired tag names, and divides the target objects matching each other into groups to perform information sharing and visualization.

13. The method of generating a process model and 3D model integrated education and training system according to claim 9, wherein the linking visualization information comprises:
acquiring calculated IoT reference information and measured IoT information from the process model;
visualizing the IoT information in a 3D model corresponding to a source;
acquiring at least one of laws, regulations, guidelines, drawings, videos, photos, and manual information concerning an industry group including the process model and the 3D model as theory information, and classifying the theory information according to preset criteria; and
tagging the classified theory information to a particular object among the integrated education models according to preset criteria, and calling the tagged theory information according to a user's action.

14. The method of generating a process model and 3D model integrated education and training system according to claim 13, wherein:
the IoT information comprises operation information and state information which can be measured through a particular sensor in a target object, the operation information comprises any one of an operation state/non-operation state, and the state information comprises at least one of temperature, pressure, flow rate, rotational speed, speed, electric energy, voltage, current, and level.

15. The method of generating a process model and 3D model integrated education and training system according to claim 14, wherein:
the state information is acquired when the operation information of the target object is in the operation state, and
the visualization is performed using at least one of text, color, and graph.

16. The method of generating a process model and 3D model integrated education and training system according to claim 9, wherein the outputting the determined UI information to the output device comprises:
acquiring, as output device information, information on the number and type of the output devices connected to output the integrated education model; and
determining the UI information to be output using the output device information and the preset UI output reference information, and outputting it to the output device.
